(19) United States
(12) Patent Application Publication
(10) Pub. No.: US 2010/0027123 A1
(43) Pub. Date: Feb. 4, 2010

(54) ANTI-REFLECTION COATING, OPTICAL MEMBER COMPRISING IT, AND EXCHANGE LENS UNIT AND IMAGING DEVICE COMPRISING SUCH OPTICAL MEMBER

(75) Inventors: Hiroaki IMAI, Kanagawa (JP); Kazuhiro YAMADA, Saitama (JP); Takanobu SHIOKAWA, Kanagawa (JP); Hiroyuki NAKAYAMA, Tokyo (JP); Mineta SUZUKI, Saitama (JP)

Correspondence Address: GREENBLUM & BERNSTEIN, P.L.C., 1950 ROLAND CLARKE PLACE, RESTON, VA, 20191, US

(73) Assignees: KEIO UNIVERSITY, Tokyo (JP); HOYA CORPORATION, Tokyo (JP)

(21) Appl. No.: 12/510,454

(22) Filed: Jul. 28, 2009

(30) Foreign Application Priority Data
Jul. 31, 2008 (JP) 2008-198209

(51) Int. Cl. G02B 1/11; B32B 5/22

(52) U.S. Cl. 359/586; 428/317.9

(57) ABSTRACT

An anti-reflection coating laminated on a substrate, wherein in a wavelength range of 400-700 nm, the substrate has a refractive index of 1.45-1.72, the first layer is based on alumina, the second to sixth layers are dense layers having refractive indices of 1.95-2.23, 1.33-1.50, 2.04-2.24, 1.33-1.50 and 1.85-2.40, respectively, the seventh layer is composed of nanometer-sized, mesoporous silica particles, and the first to seventh layers have optical thicknesses of 25.0-250.0 nm, 27.5-52.5 nm, 37.5-54.0 nm, 45.0-62.5 nm, 77.5-102.5 nm, 16.0-26.5 nm and 112.5-162.5 nm, respectively.

### FIELD OF THE INVENTION

The present invention relates to an anti-reflection coating for a visible light range suitable for exchange lens units and imaging devices, an optical member having such an anti-reflection coating, and an exchange lens unit and an imaging device comprising such an optical member.

### BACKGROUND OF THE INVENTION

A high-performance, single-focus or zoom lens unit widely used in single-lens reflex cameras, video cameras, etc. generally has about 10-40 lenses in a lens barrel. In a wide-angle lens unit for producing wide images, light has a large incident angle in its peripheral region. These lenses are provided with multilayer anti-reflection coatings comprising dielectric layers having various refractive indices different from that of a substrate, the dielectric layers being as thick as 1/2λ or 1/4λ, wherein λ is a center wavelength, to utilize an interference effect.

In addition, lenses may be tarnished or scratched in their production processes. Tarnish includes blue tarnish and white tarnish. The blue tarnish is a thin film formed by basic components in optical glass dissolved into dew attached to a surface of the optical glass left in the air, or water during a grinding step. The white tarnish is white blot generated by the chemical reaction of components eluted from glass.

Japanese Patent 3509804 discloses an optical member comprising a thin, multilayer optical coating formed on an optical substrate, at least one layer in the coating being an alkaline earth metal fluoride layer formed by a wet process. However, the alkaline earth metal fluoride layer has as high a refractive index as about 1.39.

JP 2005-352303 A and JP 2006-3562 A disclose an anti-reflection coating comprising pluralities of layers each having a physical thickness of 15-200 nm, which are formed on a substrate such that their refractive indices decrease gradually from the substrate side, the refractive index difference between adjacent layers and between the innermost layer and the substrate being 0.02-0.2, and the outermost layer being a silica aerogel layer. However, the silica aerogel layer has low scratch resistance and durability.

JP 2006-130889 A discloses a thin, mesoporous silica coating having nano-sized pores, a refractive index of 1.05-1.3, and as high transmittance as 90% or more in a wavelength range from visible light to near infrared light. This thin, mesoporous silica coating is formed by coating a solution comprising a surfactant, a silica-forming material such as tetraethoxysilane, water, an organic solvent, and acid or alkali onto a substrate to form an organic-inorganic composite coating, drying this coating, and photo-oxidizing it to remove organic components.

Japanese Patent 3668126 discloses a method for forming a porous silica coating having a low refractive index, by preparing a solution comprising a ceramic precursor such as tetraethoxysilane, a catalyst, a surfactant and a solvent, coating the solution onto a substrate, and removing the solvent and the surfactant.

However, because the thin, mesoporous silica coating of JP 2006-130889 A and the porous silica coating of Japanese Patent 3668126 are formed by hydrolysis and polycondensation for forming a thin silicate network around surfactant micelle, the hydrolysis and polycondensation takes a long period of time, and the resultant coating is not uniform.

JP 5-85778 A discloses an optical member comprising an anti-reflection coating having pluralities of dielectric layers formed on an optical substrate having high transmittance, the innermost layer being made of SiOₓ (1≦x≦2) and having a thickness nd of 0.25λ₀ or more, wherein λ₀ is a designed wavelength. Although this structure makes tarnish and scratches on the optical substrate surface less discernable, it fails to prevent tarnish.

### OBJECT OF THE INVENTION

Accordingly, an object of the present invention is to provide a uniform anti-reflection coating formed on a glass substrate having a low or medium refractive index, which has excellent transmittance as well as excellent scratch resistance and tarnish-preventing effect, without suffering flare and ghost, and an optical member having such an anti-reflection coating, and an exchange lens unit and an imaging device comprising such an optical member.

### DISCLOSURE OF THE INVENTION

As a result of intensive research in view of the above object, the inventors have found that an anti-reflection coating having the following layer structure formed on a glass substrate having a low or medium refractive index has excellent anti-reflection performance, scratch resistance, durability and uniformity, as well as good effects of preventing flare, ghost and tarnish. The present invention has been completed based on such finding.

The anti-reflection coating of the present invention comprises first to seventh layers formed on a substrate in this order, the substrate having a refractive index of 1.45-1.72, the first layer being an alumina-based, dense layer having an optical thickness of 25.0-250.0 nm, the second layer being a dense layer having a refractive index of 1.95-2.23 and an optical thickness of 27.5-52.5 nm, the third layer being a dense layer having a refractive index of 1.33-1.50 and an optical thickness of 37.5-54.0 nm, the fourth layer being a dense layer having a refractive index of 2.04-2.24 and an optical thickness of 45.0-62.5 nm, the fifth layer being a dense layer having a refractive index of 1.33-1.50 and an optical thickness of 77.5-102.5 nm, the sixth layer being a dense layer having a refractive index of 1.85-2.40 and an optical thickness of 16.0-26.5 nm, the seventh layer is a porous layer of nanometer-sized, mesoporous silica particles having a refractive index of 1.09-1.19 and an optical thickness of 112.5-162.5 nm, in a wavelength range of 400-700 nm.

The nanometer-sized, mesoporous silica particles preferably have an average diameter of 200 nm or less.

The nanometer-sized, mesoporous silica particles preferably have a hexagonal structure.

The pore diameter distribution of the seventh layer preferably has two peaks. One peak is in a range of 2-10 nm attributed to pores in particles, and another peak is in a range of 5-200 nm attributed to pores among particles. The volume ratio of the pores in particles to the pores among particles is preferably 1/15 to 1/1.

The seventh layer preferably has porosity of 55-80%.

The first layer preferably has a refractive index of 1.58-1.71.

The second, fourth and sixth layers are preferably made of at least one selected from the group consisting of Ta₂O₅, TiO₂, Nb₂O₅, ZrO₂, HfO₂, CeO₂, SnO₂, In₂O₃, ZnO, Y₂O₃ and Pr₆O₁₁, and the third and fifth layers are preferably made of at least one selected from the group consisting of MgF₂, SiO₂ and Al₂O₃.

The anti-reflection coating preferably has reflectance of 0.3% or less to light in a wavelength range of 450-600 nm at an incident angle of 0°.

The anti-reflection coating preferably further comprises a fluororesin layer of 0.4-100 nm in thickness having water repellency or water/oil repellency on the seventh layer.

The first to sixth layers are preferably formed by a vacuum vapor deposition method. The seventh layer is preferably formed by a sol-gel method.

The seventh layer is preferably formed by (i) aging a mixture solution comprising a solvent, an acid catalyst, alkoxysilane, a cationic surfactant and a nonionic surfactant, thereby causing the hydrolysis and polycondensation of the alkoxysilane; (ii) adding a base catalyst to the resultant silicate-containing acidic sol, to prepare a sol containing nanometer-sized, mesoporous silica particles containing the cationic surfactant in pores and covered with the nonionic surfactant; (iii) applying the sol to the sixth layer; (iv) drying the resultant coating to remove the solvent; and (v) baking the coating to remove the cationic surfactant and the nonionic surfactant.

The optical member of the present invention comprises the above anti-reflection coating.

The exchange lens unit of the present invention comprises the above optical member.

The imaging device of the present invention comprises the above optical member.

### BRIEF DESCRIPTION OF THE DRAWINGS

FIG. 1 is a cross-sectional view showing an anti-reflection coating formed on a substrate according to an embodiment of the present invention.

FIG. 2 is a perspective view showing one example of mesoporous silica particles constituting the seventh layer in the anti-reflection coating of FIG. 1.

FIG. 3 is a graph showing the pore diameter distribution of the seventh layer in the anti-reflection coating of FIG. 1.

FIG. 4 is a cross-sectional view showing an anti-reflection coating formed on a substrate according to another embodiment of the present invention.

FIG. 5 is a graph showing the spectral reflectance of the anti-reflection coating of Example 1.

FIG. 6 is a graph showing the spectral reflectance of the anti-reflection coating of Example 2.

FIG. 7 is a graph showing the spectral reflectance of the anti-reflection coating of Example 3.

FIG. 8 is a schematic view showing one example of an apparatus for forming an anti-reflection coating.

### DESCRIPTION OF THE PREFERRED EMBODIMENTS

[1] Substrate

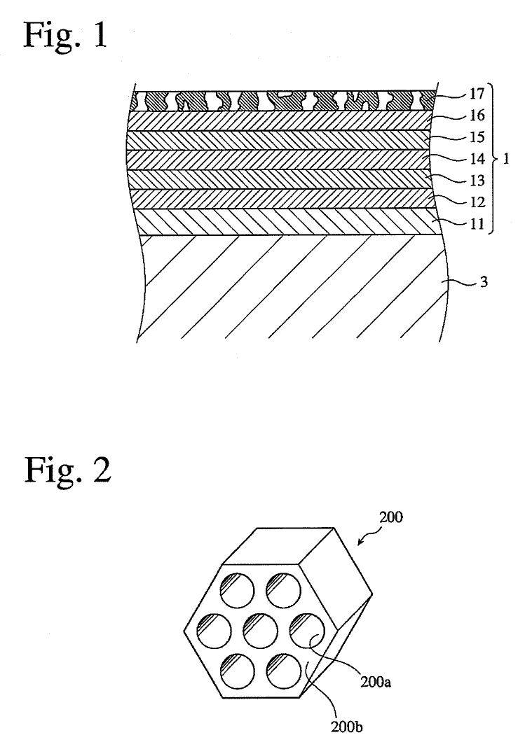

The anti-reflection coating 1 of the present invention formed on a substrate 3 is shown in FIG. 1. The substrate 3 shown in FIG. 1 is a flat plate, but it may be a lens, a prism, a light guide, a diffraction grating, etc. The substrate 3 may be made of glass, crystalline materials or plastics. Specific examples of materials for the substrate 3 include optical glass such as LF5, BK7, BAK1, BAK2, K3, PSK2, SK4, SK5, SK7, SK11, SK12, SK14, SK15, SK16, SK18, KF3, SK6, SK8, BALF2, SSK5, LLF1, LLF2, LLF6, BAF10, BAF11, BAF12, F1, F5, F8, F16, SF2, SF7, KZF2, KZF5, LAK11, LAK12, etc., Pyrex (registered trademark) glass, quartz, soda lime glass, white crown glass, etc.

The refractive index of the substrate 3 in a wavelength range of 400-700 nm is 1.45-1.72, preferably 1.51-1.60. The substrate 3 with a refractive index in this range has improved optical performance in a visible wavelength range, enabling the size reduction of exchange lens units.

[2] Anti-Reflection Coating

(1) Structure of Anti-Reflection Coating

The anti-reflection coating 1 formed on a substrate 3 comprises first to seventh layers each made of a predetermined material and having a predetermined refractive index and optical thickness [refractive index (n)×physical thickness (d)]. Namely, the anti-reflection coating 1 of the present invention comprises a first layer 11 which is an alumina-based, dense layer having an optical thickness of 25.0-250.0 nm, a second layer 12 which is a dense layer having a refractive index of 1.95-2.23 and an optical thickness of 27.5-52.5 nm, a third layer 13 which is a dense layer having a refractive index of 1.33-1.50 and an optical thickness of 37.5-54.0 nm, a fourth layer 14 which is a dense layer having a refractive index of 2.04-2.24 and an optical thickness of 45.0-62.5 nm, a fifth layer 15 which is a dense layer having a refractive index of 1.33-1.50 and an optical thickness of 77.5-102.5 nm, a sixth layer 16 which is a dense layer having a refractive index of 1.85-2.40 and an optical thickness of 16.0-26.5 nm, and a seventh layer 17 which is a porous layer of nanometer-sized, mesoporous silica particles having a refractive index of 1.09-1.19 and an optical thickness of 112.5-162.5 nm, in a wavelength range of 400-700 nm.

The reflectance of the anti-reflection coating 1 to light in a wavelength range of 450-600 nm at an incident of 0° is preferably 0.3% or less, more preferably 0.25% or less.

(2) First Layer

The first layer 11 in the anti-reflection coating 1 is an alumina-based dense layer. The first layer 11 is preferably formed only by alumina (aluminum oxide). Alumina preferably has purity of 99% or more.

The refractive index of the alumina-based, first layer (alumina layer) 11 is preferably 1.58-1.71, more preferably 1.60-1.70. The first layer 11 preferably has an optical thickness of 120.0-210.0 nm. Alumina has high adhesion, high transmittance in a wide wavelength range, high hardness, excellent wear resistance, and good cost performance. Because alumina has excellent steam-shielding properties, the alumina-based dense layer formed as the first layer can prevent tarnish on the substrate surface.

(3) Second to Sixth Layers

The second layer 12, the fourth layer 14 and the sixth layer 16 are preferably dense layers made of at least one selected from the group consisting of Ta₂O₅, TiO₂, Nb₂O₅, ZrO₂, HfO₂, CeO₂, SnO₂, In₂O₃, ZnO, Y₂O₃ and Pr₆O₁₁, and the third layer 13 and the fifth layer 15 are preferably dense layers made of at least one selected from the group consisting of MgF₂, SiO₂ and Al₂O₃. The second layer 12 preferably has a refractive index of 2.00-2.15 and an optical thickness of 30.0-51.0 nm, the third layer 13 preferably has a refractive index of 1.35-1.48 and an optical thickness of 42.0-53.0 nm, the fourth layer 14 preferably has a refractive index of 2.05-2.15 and an optical thickness of 40.0-60.5 nm, the fifth layer 15 preferably has a refractive index of 1.35-1.47 and an optical thickness of 85.0-95.0 nm, the sixth layer 16 preferably has a refractive index of 1.95-2.30 and an optical thickness of 20.0-25.5 nm.

(4) Seventh Layer

The seventh layer 17 is formed by nanometer-sized, mesoporous silica particles, having a low refractive index and an excellent anti-reflection function. The seventh layer (mesoporous silica layer) 17 preferably has a refractive index of 1.09-1.19 and an optical thickness of 130-155 nm. In the seventh layer 17, pores among particles are preferably 5-100 nm in diameter, and the porosity is preferably 55-80%, more preferably 56.5-79.0%. Unlike conventional silica aerogel, the nanometer-sized, mesoporous silica particles have a hexagonal structure with meso-pores arranged regularly and uniformly. Accordingly, they have high strength and porosity, low refractive index, and excellent scratch resistance. The nanometer-sized, mesoporous silica particles constituting the seventh layer 17 are not restricted to a hexagonal structure, but may have a cubic or ramera structure.

FIG. 2 shows one example of the hexagonal structures of the nanometer-sized, mesoporous silica particles. A nanometer-sized, mesoporous silica particle 200 has a porous structure constituted by a silica skeleton 200b having meso-pores 200a arranged hexagonally and regularly. The average diameter of the nanometer-sized, mesoporous silica particles 200 is preferably 200 nm or less, more preferably 20-50 nm. When this average diameter is more than 200 nm, it is difficult to control the thickness of the mesoporous silica layer 17, resulting in low anti-reflection performance and scratch resistance. The average diameter of the nanometer-sized, mesoporous silica particles 200 is measured by a dynamic light-scattering method. The refractive index of the mesoporous silica layer 17 depends on its porosity: the larger the porosity, the smaller the refractive index.

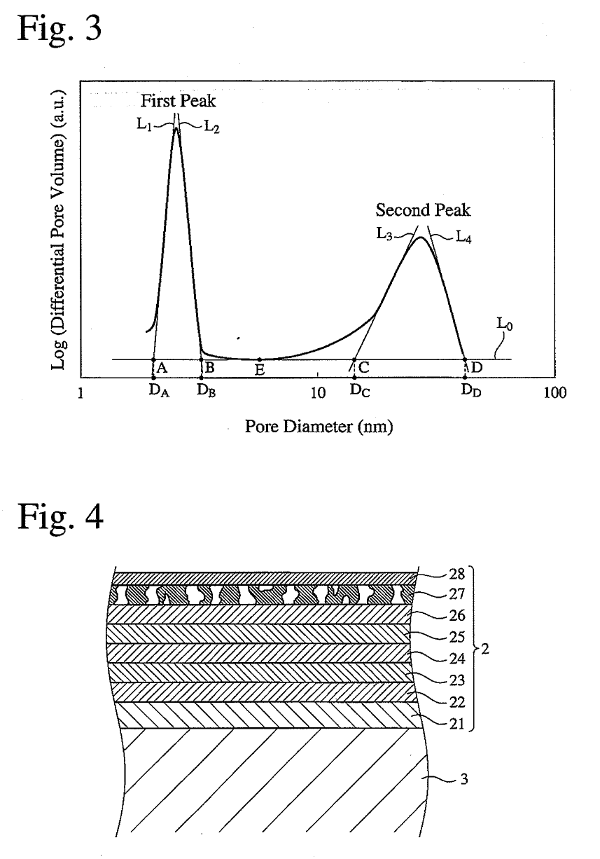

As shown in FIG. 3, the pore diameter distribution of the mesoporous silica layer 17 preferably has two peaks. This pore diameter distribution is preferably determined by a nitrogen adsorption method. Specifically, the pore diameter distribution curve is determined from the isothermal nitrogen desorption curve of the mesoporous silica layer 17 by analysis by a BJH method, in which the axis of abscissas represents a pore diameter, and the axis of ordinates represents log (differential pore volume). The BJH method is described, for instance, in “Method for Determining Distribution of Meso-Pores,” E. P. Barrett, L. G. Joyner, and P. P. Halenda, J. Am. Chem. Soc., 73, 373 (1951). Log (differential pore volume) is expressed by dV/d (log D), in which dV represents small pore volume increment, and d (log D) represents the small increment of log (pore diameter D).

A first peak on the smaller pore diameter side is attributed to the diameters of pores in particles, and a second peak on the larger pore diameter side is attributed to the diameters of pores among particles. The mesoporous silica layer 17 preferably has a pore diameter distribution having the first peak in a range of 2-10 nm and the second peak in a range of 5-200 nm.

A ratio of the total volume V₁ of pores in particles to the total volume V₂ of pores among particles is preferably 1/15 to 1/1. The mesoporous silica layer 17 having this ratio V₁/V₂ within the above range has as small refractive index as 1.19 or less. The ratio V₁/V₂ is more preferably 1/10 or more and less than 1/1.5. The total volumes V₁ and V₂ are determined by the following method. In FIG. 3, a straight line passing a point E of the minimum value in the ordinate between the first and second peaks and in parallel with the axis of abscissas is defined as a baseline L₀, the maximum inclination lines (tangent lines at the maximum inclination points) of the first peak are defined as L₁ and L₂, and the maximum inclination lines (tangent lines at the maximum inclination points) of the second peak are defined as L₃ and L₄. Values in the abscissas at intersections A to D between the maximum inclination lines L₁ to L₄ and the baseline L₀ are defined as D_{A} to D_{D}. By a BJH method, the total volume V₁ of pores in a range from D_{A} to D_{B}, and the total volume V₂ of pores in a range from D_{C} to D_{D} are calculated.

The mesoporous silica layer 17 is preferably formed by a wet method such as a sol-gel method, etc. The mesoporous silica layer 17 may be hydrophobidized to have excellent moisture resistance and durability.

(5) Fluororesin Layer

The anti-reflection coating of the present invention may have a fluororesin layer having water repellency or water/oil repellency on the outermost layer. The anti-reflection coating 2 shown in FIG. 4 comprises first to seventh layers 21-27 on the substrate 3, and further a fluororesin layer 28 thereon.

The fluororesins are not particularly restricted as long as they are colorless and highly transparent. They are preferably fluorine-containing organic compounds, or organic-inorganic hybrid polymers.

The fluorine-containing organic compounds include fluororesins and fluorinated pitch (for instance, CFn, wherein n is 1.1-1.6). Specific examples of the fluororesins include fluorine-containing olefinic polymers or copolymers, such as polytetrafluoroethylene (PTFE), tetraethylene-hexafluoropropylene copolymers (PFEP), ethylene-tetrafluoroethylene copolymers (PETFE), tetrafluoroethylene-perfluoroalkyl vinyl ether copolymers (PFA), ethylene-chlorotrifluoroethylene copolymers (PECTFE), tetrafluoroethylene-hexafluoropropylene-perfluoroalkyl vinyl ether copolymers (PEPE), polychlorotrifluoroethylene (PCTFE), polyvinylidene fluoride (PVDF), polyvinyl fluoride (PVF), etc. Commercially available fluororesins include, for instance, “OPSTAR” available from JSR Corporation, and “CYTOP” available from Asahi Glass Co., Ltd.

The fluorine-containing organic-inorganic hybrid polymers may be organic silicon polymers having fluorocarbon groups, which may be polymers obtained by the hydrolysis of silane compounds having fluorocarbon groups. The silane compounds having fluorocarbon groups may be compounds represented by the following formula (I):

CF₃(CF₂)ₐ(CH₂)₂SiR_{b}X_{c} (1),

wherein R is an alkyl group, X is an alkoxyl group or a halogen atom, a is an integer of 0-7, b is an integer of 0-2, c is an integer of 1-3, and b+c=3. Specific examples of the compounds represented by the formula (I) include CF₃(CH₂)₂Si(OCH₃)₃, CF₃(CH₂)₂SiCl₃, CF₃(CF₂)₅(CH₂)₂Si(OCH₃)₃, CF₃(CF₂)₅(CH₂)₂SiCl₃, CF₃(CF₂)₇(CH₂)₂Si(OCH₃)₃, CF₃(CF₂)₇(CH₂)₂SiCl₃, CF₃(CF₂)₇(CH₂)₂SiCH₃(OCH₃)₂, CF₃(CF₂)₇(CH₂)₂SiCH₃Cl₂, etc. Examples of commercially available organic silicon polymers include Novec EGC-1720 available from Sumitomo 3M Ltd., XC98-B2472 available from GE Toshiba Silicone Co., Ltd., X71-130 available from Shin-Etsu Chemical Co., Ltd., etc.

The fluororesin layer 28 is as thick as preferably 0.4-100 nm, more preferably 10-80 nm. When the thickness of the fluororesin layer 28 is less than 0.4 nm, sufficient water/oil repellency cannot be obtained. On the other hand, with the fluororesin layer thicker than 100 nm, the anti-reflection coating has deteriorated transparency and degraded optical properties. The refractive index of the fluororesin layer 28 is preferably 1.5 or less, more preferably 1.45 or less. Although the fluororesin layer 28 may be formed by a vacuum vapor deposition method, it is preferably formed by a wet method such as a sol-gel method.

[3] Formation Method of Anti-Reflection Coating

(1) Formation Method of First to Sixth Layers

The first to sixth layers 11-16 are preferably formed by a physical vapor deposition method, such as a vacuum vapor deposition method and a sputtering method. From the aspect of production cost and precision, the vacuum vapor deposition method is particularly preferable. The vacuum vapor deposition method may be a resistor-heating type or an electron beam type.

The electron-beam-type vacuum vapor deposition method will be explained below. A vacuum vapor deposition apparatus 30 shown in FIG. 8 comprises, in a vacuum chamber 31, a rotatable rack 32 for carrying pluralities of substrates 3 on its inner surface, a vapor source 33 comprising a crucible 36 containing an evaporating material, an electron beam irradiator 38, a heater 39, and a vacuum pump connector 35 connected to a vacuum pump 40. To form the first to sixth layers 11-16 on each substrate 3, each substrate 3 is attached to the rotatable rack 32 with its surface toward the vapor source 33, and the evaporating material 37 is placed in the crucible 36. After the vacuum chamber 31 is evacuated by the vacuum pump 40 connected to the vacuum pump connector 35, each substrate 3 is heated by the heater 39. While rotating the rack 32 by a shaft 34, electron beams are irradiated from the electron beam irradiator 38 to the evaporating material 37 to heat it. The vaporized material 37 is deposited on each substrate 3, so that each layer is formed on the substrate 3.

In the vacuum vapor deposition method, the initial degree of vacuum is preferably 1.0×10⁻⁵ Torr to 1.0×10⁻⁶ Torr. When the degree of vacuum is less than 1.0×10⁻⁵ Torr, insufficient vapor deposition occurs. When the degree of vacuum is more than 1.0×10⁻⁶ Torr, it takes too much time for vapor deposition. To increase the precision of the formed layers, it is preferable to heat the substrates 3 during vapor deposition. The substrate temperature during vapor deposition may be properly determined based on the heat resistance of the substrates 3 and the vapor deposition speed, but it is preferably 60-250° C.

(2) Formation Method of Seventh Layer

The seventh layer (mesoporous silica layer) 17 is formed by (i) aging a mixture solution comprising a solvent, an acid catalyst, alkoxysilane, a cationic surfactant and a nonionic surfactant, thereby causing the hydrolysis and polycondensation of the alkoxysilane; (ii) adding a base catalyst to the resultant silicate-containing acidic sol, to prepare a sol containing nanometer-sized, mesoporous silica particles containing the cationic surfactant in pores and covered with the nonionic surfactant (surfactants-containing, nano-sized, mesoporous silica composite particles); (iii) applying this sol to the sixth layer 16; (iv) drying the resultant coating to remove the solvent; and (v) baking the coating to remove the cationic surfactant and the nonionic surfactant.

(a) Starting Materials

(a-1) Alkoxysilane

The alkoxysilane may be a monomer or an oligomer. The alkoxysilane monomer preferably has 3 or more alkoxy groups. The use of the alkoxysilane having 3 or more alkoxy groups as a starting material provides a mesoporous silica coating with excellent uniformity. Specific examples of the alkoxysilane monomers include methyltrimethoxysilane, methyltriethoxysilane, phenyltriethoxysilane, tetramethoxysilane, tetraethoxysilane, tetrapropoxysilane, tetrabutoxysilane, diethoxydimethoxysilane, dimethyldimethoxysilane, dimethyldiethoxysilane, etc. The alkoxysilane oligomers are preferably polycondensates of these monomers. The alkoxysilane oligomers can be obtained by the hydrolysis and polycondensation of the alkoxysilane monomers. Specific examples of the alkoxysilane oligomers include silsesquioxane represented by the general formula: RSiO_{1.5}, wherein R represents an organic functional group.

(a-2) Surfactants

(i) Cationic Surfactants

Specific examples of the cationic surfactants include alkyl trimethyl ammonium halides, alkyl triethyl ammonium halides, dialkyl dimethyl ammonium halides, alkyl methyl ammonium halides, alkoxy trimethyl ammonium halides, etc. The alkyl trimethyl ammonium halides include lauryl trimethyl ammonium chloride, cetyl trimethyl ammonium chloride, cetyl trimethyl ammonium bromide, stearyl trimethyl ammonium chloride, benzyl trimethyl ammonium chloride, behenyl trimethyl ammonium chloride, etc. The alkyl trimethyl ammonium halides include n-hexadecyl trimethyl ammonium chloride, etc. The dialkyl dimethyl ammonium halides include distearyl dimethyl ammonium chloride, stearyl dimethylbenzyl ammonium chloride, etc. The alkyl methyl ammonium halides include dodecyl methyl ammonium chloride, cetyl methyl ammonium chloride, stearyl methyl ammonium chloride, benzyl methyl ammonium chloride, etc. The alkoxy trimethyl ammonium halides include octadesiloxypropyl trimethyl ammonium chloride, etc.

(ii) Nonionic Surfactants

The nonionic surfactants include block copolymers of ethylene oxide and propylene oxide, polyoxyethylene alkylethers, etc. The block copolymers of ethylene oxide and propylene oxide include, for instance, those represented by the formula of RO(C₂H₄O)ₐ—(C₃H₆O)_{b}—(C₂H₄O)_{c}R, wherein a and c are respectively 10-120, b is 30-80, and R is a hydrogen atom or an alkyl group having 1-12 carbon atoms. The block copolymers are commercially available as, for instance, Pluronic (registered trademark of BASF). The polyoxyethylene alkyl ethers include polyoxyethylene lauryl ether, polyoxyethylene cetyl ether, polyoxyethylene stearyl ether, etc.

(a-3) Catalysts

(i) Acid Catalysts

Specific examples of the acid catalysts include inorganic acids such as hydrochloric acid, sulfuric acid, nitric acid, etc. and organic acids such as formic acid, acetic acid, etc.

(ii) Base Catalysts

Specific examples of the base catalysts include ammonia, amines, NaOH and KOH. The preferred examples of the amines include alcohol amines and alkyl amines (methylamine, dimethylamine, trimethylamine, n-butylamine, n-propylamine, etc.).

(a-4) Solvents

The solvent is preferably pure water.

(b) Formation Method

(b-1) Hydrolysis and Polycondensation Under Acidic Conditions

An acid catalyst is added to the solvent to prepare an acidic solution, to which a cationic surfactant and a nonionic surfactant are added to prepare a mixture solution. Alkoxysilane is added to this acidic mixture solution to cause hydrolysis and polycondensation. The acidic mixture solution preferably has pH of about 2. Because a silanol group of alkoxysilane has an isoelectric point of about pH 2, the silanol group is stable in the acidic mixture solution of about pH 2. A solvent/alkoxysilane molar ratio is preferably 30-300. When this molar ratio is less than 30, the degree of polymerization of alkoxysilane is too high. When it is more than 300, the degree of polymerization of alkoxysilane is too low.

A cationic surfactant/solvent molar ratio is preferably 1×10⁻⁴ to 3×10⁻³, to provide nanometer-sized, mesoporous silica particles with excellent regularity of meso-pores. This molar ratio is more preferably 1.5×10⁻⁴ to 2×10⁻³.

A cationic surfactant/alkoxysilane molar ratio is preferably 1×10⁻¹ to 3×10⁻¹. When this molar ratio is less than 1×10⁻¹, the formation of the meso-structure (hexagonal arrangement) of nanometer-sized, mesoporous silica particles is insufficient. When it is more than 3×10⁻¹, the nanometer-sized, mesoporous silica particles have too large diameters. This molar ratio is more preferably 1.5×10⁻¹ to 2.5×10⁻¹.

A nonionic surfactant/alkoxysilane molar ratio is preferably 5.0×10⁻³ to 4.0×10⁻². When this molar ratio is less than 5.0×10⁻³, the mesoporous silica layer has a refractive index exceeding 1.19. When it is more than 4.0×10⁻², the mesoporous silica layer 17 has a refractive index less than 1.09.

A cationic surfactant/nonionic surfactant molar ratio is preferably 5-35 to provide nanometer-sized, mesoporous silica particles with excellent regularity of meso-pores. This molar ratio is more preferably 6-30.

The alkoxysilane-containing solution is strongly stirred at 20-25° C. for 1-24 hours for aging. The hydrolysis and polycondensation proceed by aging, to form an acidic sol containing silicate oligomers.

(b-2) Hydrolysis and Polycondensation Under Basic Conditions

A base catalyst is added to the acidic sol to turn the solution basic, to further conduct the hydrolysis and polycondensation. The resultant basic sol preferably has pH of 9-12. A silicate skeleton is formed around a cationic surfactant micelle by the addition of the base catalyst, and grows with regular hexagonal arrangement, thereby forming composite particles of silica and the cationic surfactant. As the composite particles grow, effective charge on their surfaces decreases, so that the nonionic surfactant is adsorbed to their surfaces, resulting in a sol of nano-sized, mesoporous silica particles containing the cationic surfactant in pores and covered with the nonionic surfactant, whose shape is shown in FIG. 2. See, for instance, Hiroaki Imai, “Chemical Industries,” September, 2005, Vol. 56, No. 9, pp. 688-693, issued by Kagaku Kogyo-Sha.

In the process of forming the surfactants-containing, nano-sized, mesoporous silica composite particles, its growth is suppressed by the adsorption of the nonionic surfactant. Accordingly, the surfactants-containing, nano-sized, mesoporous silica composite particles obtained by using two types of surfactants (a cationic surfactant and a nonionic surfactant) have an average diameter of 200 nm or less and excellent regularity of meso-pores.

(b-3) Coating

A sol containing the surfactants-containing, nano-sized, mesoporous silica composite particles is coated onto the sixth layer. The sol may be coated by a spin-coating method, a dip-coating method, a spray-coating method, a flow-coating method, a bar-coating method, a reverse-coating method, a flexographic printing method, a printing method, or their combination. The thickness of the resultant porous coating can be controlled, for instance, by the adjustment of a substrate-rotating speed in the spin-coating method, by the adjustment of pulling-up speed in the dipping method, or by the adjustment of a concentration in the coating solution. The substrate-rotating speed in the spin-coating method is preferably 500-10,000 rpm.

To provide the sol containing surfactants-containing, nano-sized, mesoporous silica composite particles with proper concentration and fluidity, a basic aqueous solution having the same pH as that of the sol may be added as a dispersing medium before coating. The percentage of the surfactants-containing, nano-sized, mesoporous silica composite particles in the coating solution is preferably 10-50% by mass to obtain a uniform porous layer.

(b-4) Drying

The solvent is evaporated from the coated sol. The drying conditions of the coating are not restricted, but may be properly selected depending on the heat resistance of the substrate 3 and the first to sixth layers, etc. The coating may be spontaneously dried, or heat-treated at a temperature of 50-200° C. for 15 minutes to 1 hour for accelerated drying.

(b-5) Baking

The dried coating is baked to remove the cationic surfactant and the nonionic surfactant, thereby forming a mesoporous silica layer 17. The baking temperature is preferably 300° C. to 500° C. When the baking temperature is lower than 300° C., baking is insufficient. When the baking temperature exceeds 500° C., the resultant anti-reflection coating 1 has a refractive index exceeding 1.19. The baking temperature is more preferably 350° C. to 450° C. The baking time is preferably 1-6 hours, more preferably 2-4 hours.

[4] Optical Member Comprising Anti-Reflection Coating

An optical member comprising the anti-reflection coating of the present invention having excellent anti-reflection performance and scratch resistance is suitable for exchange lens units for single-lens reflex cameras, and imaging devices for single-lens reflex cameras and video cameras.

The present invention will be explained in further detail by Examples below without intention of restricting the present invention thereto.

### Example 1

An anti-reflection coating 1 having the layer structure shown in Table 1 was produced by the following steps. The refractive index of each layer was measured with light having a wavelength of 550 nm.

[1] Formation of First to Sixth Layers

Using the apparatus shown in FIG. 8, the first to sixth dense layers shown in Table 1 were formed on an optical lens of LF5 by an electron-beam vacuum vapor deposition method at an initial degree of vacuum of 1.2×10⁻⁵ Torr and a substrate temperature of 230° C.

[2] Formation of Seventh Layer

40 g of hydrochloric acid (0.01 N) having pH of 2 was mixed with 1.21 g (0.088 mol/L) of n-hexadecyltrimethylammonium chloride (available from Kanto Chemical Co. Ltd.), and 7.58 g (0.014 mol/L) of a block copolymer of HO(C₂H₄O)₁₀₆—(C₃H₆O)₇₀—(C₂H₄O)₁₀₆H (“Pluronic F127” available from Sigma-Aldrich), stirred at 23° C. for 1 hour, mixed with 4.00 g (0.45 mol/L) of tetraethoxysilane (available from Kanto Chemical Co. Ltd.), stirred at 23° C. for 3 hours, mixed with 3.94 g (1.51 mol/L) of 28-%-by-mass ammonia water to adjust the pH to 11, and then stirred at 23° C. for 0.5 hours. The resultant composite solution of a surfactant and nano-sized, mesoporous silica particles was spin-coated on the sixth layer, dried at 80° C. for 0.5 hours, and then baked at 400° C. for 3 hours.

With the outermost layer in contact with air as a medium, the characteristics of the resultant anti-reflection coating were measured. A lens reflectance meter (“USPM-RU” available from Olympus Optical Co., Ltd.) was used for the measurement of refractive index and physical thickness. The seventh layer had a ratio V₁/V₂ of 1/2.1.

TABLE 1

| | | Refractive | Optical |
|---|---|---|---|
| No. | Material | Index | Thickness (nm) |
| Substrate | LF5 | 1.584 | — |
| First Layer | Al₂O₃ | 1.650 | 147.5 |
| Second Layer | Ta₂O₅ + Y₂O₃ + Pr₆O₁₁ | 2.050 | 40.4 |
| Third Layer | MgF₂ | 1.380 | 47.1 |
| Fourth Layer | Ta₂O₅ + Y₂O₃ + Pr₆O₁₁ | 2.050 | 53.9 |
| Fifth Layer | MgF₂ | 1.380 | 90.3 |
| Sixth Layer | Ta₂O₅ + Y₂O₃ + Pr₆O₁₁ | 2.050 | 21.1 |
| Seventh Layer | Mesoporous Silica | 1.091 | 143.0 |
| Medium | Air | 1.000 | — |

### Example 2

An anti-reflection coating having the layer structure shown in Table 2 was formed in the same manner as in Example 1 except for adding 2.14 g (0.004 mol/L) of the above block copolymer “Pluronic F127.” With the outermost layer in contact with air as a medium, the characteristics of the anti-reflection coating were measured in the same manner as in Example 1. The seventh layer had a ratio V₁/V₂ of 1/1.7. The outermost surface of the anti-reflection coating had excellent scratch resistance.

TABLE 2

| | | Refractive | Optical Thickness |
|---|---|---|---|
| No. | Material | Index | (nm) |
| Substrate | LF5 | 1.584 | — |
| First Layer | Al₂O₃ | 1.650 | 200.0 |
| Second Layer | Ta₂O₅ + Y₂O₃ + Pr₆O₁₁ | 2.050 | 50.0 |
| Third Layer | MgF₂ | 1.380 | 52.5 |
| Fourth Layer | Ta₂O₅ + Y₂O₃ + Pr₆O₁₁ | 2.050 | 60.0 |
| Fifth Layer | MgF₂ | 1.380 | 90.0 |
| Sixth Layer | Ta₂O₅ + Y₂O₃ + Pr₆O₁₁ | 2.050 | 25.0 |
| Seventh Layer | Mesoporous Silica | 1.182 | 140.0 |
| Medium | Air | 1.000 | — |

### Example 3

An anti-reflection coating having the layer structure shown in Table 3 was formed in the same manner as in Example 1 except for adding 4.32 g (0.008 mol/L) of the above block copolymer “Pluronic F127.” With the outermost layer in contact with air as a medium, the characteristics of the anti-reflection coating were measured in the same manner as in Example 1. The seventh layer had a ratio V₁/V₂ of 1/1.9. The outermost surface of the anti-reflection coating had excellent scratch resistance.

TABLE 3

| | | Refractive | Optical |
|---|---|---|---|
| No. | Material | Index | Thickness (nm) |
| Substrate | LF5 | 1.584 | — |
| First Layer | Al₂O₃ | 1.650 | 147.5 |
| Second Layer | Ta₂O₅ + Y₂O₃ + Pr₆O₁₁ | 2.050 | 40.4 |
| Third Layer | MgF₂ | 1.380 | 47.1 |
| Fourth Layer | Ta₂O₅ + Y₂O₃ + Pr₆O₁₁ | 2.050 | 53.9 |
| Fifth Layer | MgF₂ | 1.380 | 90.3 |
| Sixth Layer | Ta₂O₅ + Y₂O₃ + Pr₆O₁₁ | 2.050 | 21.1 |
| Seventh Layer | Mesoporous Silica | 1.147 | 143.0 |
| Medium | Air | 1.000 | — |

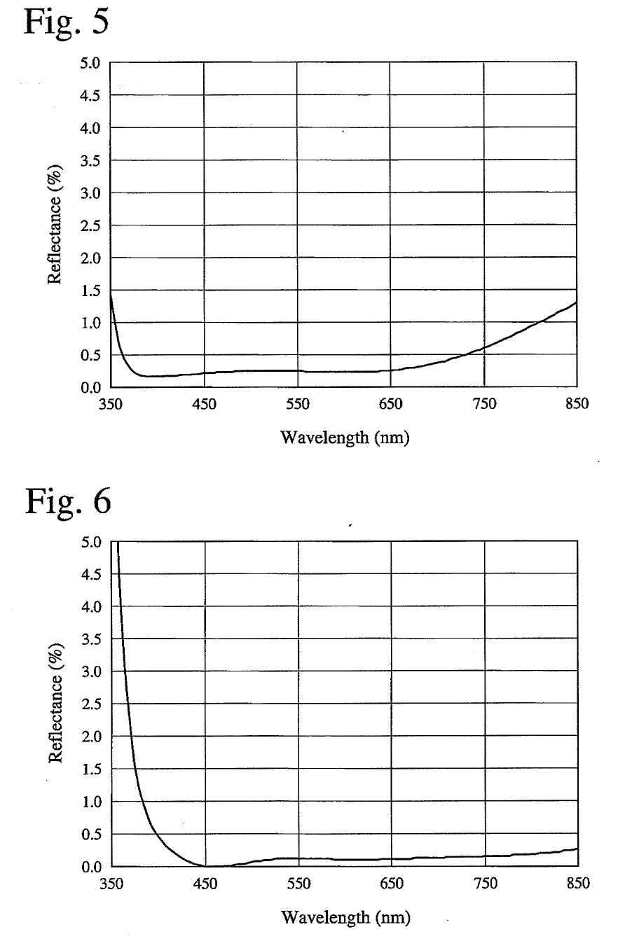

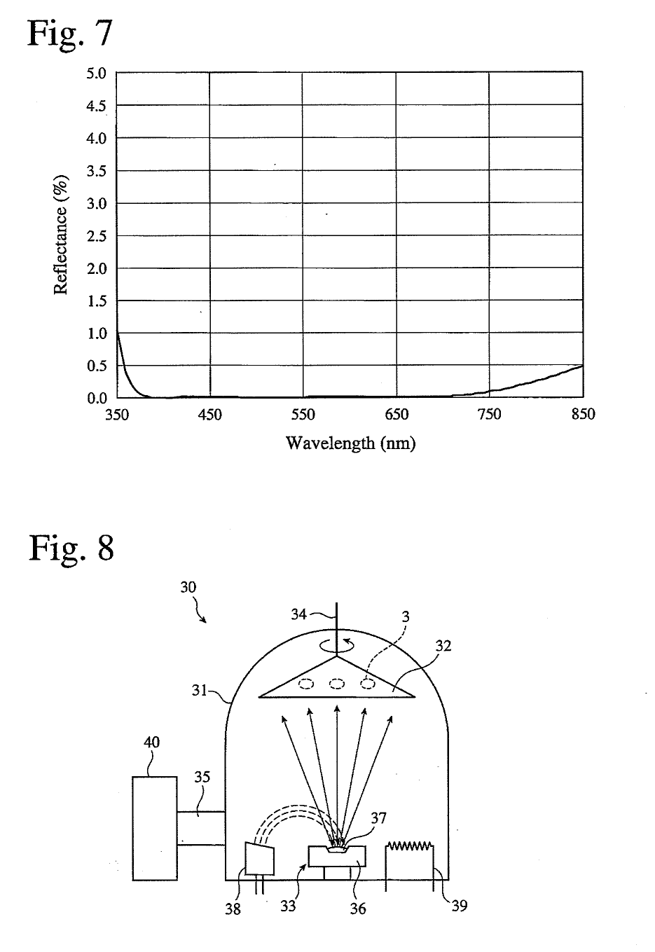

FIGS. 5-7 show the spectral reflectance characteristics of an optical lens comprising each anti-reflection coating of Examples 1-3 when light in a wavelength range of 350 nm-850 nm was cast at an incident angle of 0°.

It was found from FIGS. 5-7 that the anti-reflection coatings of Examples 1-3 had reflectance of 0.3% or less in a visible light range (wavelength: 450-600 nm) at an incident angle of 0°, excellent reflectance characteristics.

Images taken with optical lenses obtained in Examples 1-3 did not suffer flare and ghost.

### EFFECT OF THE INVENTION

The seven-layer anti-reflection coating of the present invention formed on glass substrate having a low to medium refractive index has excellent anti-reflection performance to a visible light wavelength of 400-700 nm, as well as excellent flare- and ghost-preventing effect, tarnish-preventing effect, scratch resistance, durability and uniformity. Accordingly, it is suitable for exchange lens units for single-lens reflex cameras, etc. used outdoors.

The present disclosure relates to subject matter contained in Japanese Patent Application No. 2008-198209 filed on Jul. 31, 2008, which is expressly incorporated herein by reference in its entirety.

What is claimed is:

1. An anti-reflection coating comprising first to seventh layers formed on a substrate in this order,
said substrate having a refractive index of 1.45-1.72,
said first layer being an alumina-based, dense layer having an optical thickness of 25.0-250.0 nm,
said second layer being a dense layer having a refractive index of 1.95-2.23 and an optical thickness of 27.5-52.5 nm,
said third layer being a dense layer having a refractive index of 1.33-1.50, and an optical thickness of 37.5-54.0 nm,
said fourth layer being a dense layer having a refractive index of 2.04-2.24, and an optical thickness of 45.0-62.5 nm,
said fifth layer being a dense layer having a refractive index of 1.33-1.50, and an optical thickness of 77.5-102.5 nm,
said sixth layer being a dense layer having a refractive index of 1.85-2.40, and an optical thickness of 16.0-26.5 nm, and
said seventh layer being a porous layer of nanometer-sized, mesoporous silica particles, which has a refractive index of 1.09-1.19 and an optical thickness of 112.5-162.5 nm, in a wavelength range of 400-700 nm.

2. The anti-reflection coating according to claim 1, wherein said nanometer-sized, mesoporous silica particles have an average diameter of 200 nm or less.

3. The anti-reflection coating according to claim 1, wherein said nanometer-sized, mesoporous silica particles have a hexagonal structure.

4. The anti-reflection coating according to claim 1, wherein said seventh layer has a pore diameter distribution with two peaks.

5. The anti-reflection coating according to claim 4, wherein the pore diameter distribution of said seventh layer has a peak attributed to pores in particles in a range of 2-10 nm, and a peak attributed to pores among particles in a range of 5-200 nm.

6. The anti-reflection coating according to claim 4, wherein the volume ratio of said pores in particles to said pores among particles is 1/15 to 1/1.

7. The anti-reflection coating according to claim 1, wherein said seventh layer has porosity of 55-80%.

8. The anti-reflection coating according to claim 1, wherein said first layer has a refractive index of 1.58-1.71.

9. The anti-reflection coating according to claim 1, wherein said second, fourth and sixth layers are made of at least one selected from the group consisting of Ta₂O₅, TiO₂, Nb₂O₅, ZrO₂, HfO₂, CeO₂, SnO₂, In₂O₃, ZnO, Y₂O₃ and Pr₆O₁₁, and wherein said third and fifth layers are made of at least one selected from the group consisting of MgF₂, SiO₂ and Al₂O₃.

10. The anti-reflection coating according to claim 1, wherein it has reflectance of 0.3% or less to light in a wavelength range of 450-600 nm at an incident angle of 0°.

11. The anti-reflection coating according to claim 1, wherein it further has a fluororesin layer of 0.4-100 nm in thickness having water repellency or water/oil repellency on said seventh layer.

12. The anti-reflection coating according to claim 1, wherein said first to sixth layers are formed by a vacuum vapor deposition method.

13. The anti-reflection coating according to claim 1, wherein said seventh layer is formed by a sol-gel method.

14. The anti-reflection coating according to claim 13, wherein said seventh layer is formed by (i) aging a mixture solution comprising a solvent, an acid catalyst, alkoxysilane, a cationic surfactant and a nonionic surfactant, thereby causing the hydrolysis and polycondensation of said alkoxysilane; (ii) adding a base catalyst to the resultant silicate-containing acidic sol, to prepare a sol containing nanometer-sized, mesoporous silica particles containing said cationic surfactant in pores and covered with said nonionic surfactant; (iii) applying said sol to said sixth layer; (iv) drying the resultant coating to remove said solvent; and (v) baking said coating to remove said cationic surfactant and said nonionic surfactant.

15. An optical member comprising the anti-reflection coating recited in claim 1.

16. An exchange lens unit comprising the optical member recited in claim 15.

17. An imaging device comprising the optical member recited in claim 15.
